(19) United States
(12) Patent Application Publication
(10) Pub. No.: US 2009/0029056 A1
(43) Pub. Date: Jan. 29, 2009

(54) Method for Improving the Barrier Characteristics of Ceramic Barrier Layers

(76) Inventors: Manfred Hoffmann, Konstanz (DE); Wolfgang Lohwasser, Gallingen (DE)

Correspondence Address: FISHER, CHRISTEN & SABOL, 1120 20TH STREET, NW, SOUTH TOWER, SUITE 750, WASHINGTON, DC, 20036, US

(21) Appl. No.: 11/918,038

(22) PCT Filed: Mar. 24, 2006
(86) PCT No.: PCT/EP2006/002700

§ 371 Date: Feb. 26, 2008

(30) Foreign Application Priority Data
Apr. 11, 2005 (CH) 00647/05

(51) Int. Cl. B05D 3/00

(52) U.S. Cl. 427/372.2

(57) ABSTRACT

A method for improving the permeability barrier against water vapor and gases for a flexible support material which includes at least one barrier layer consisting of a ceramic material. According to this method, the ceramic barrier layers are coated with a solution of perhydropolysilazane (PHPS), and then are cured to form a silicon oxide layer.

Method for Improving the Barrier Properties of Ceramic Barrier Layers The invention concerns a method for improving the permeation barrier effect for water vapour and gases in a flexible carrier material with at least one barrier layer of ceramic material.

Barrier layers of metal or inorganic or ceramic materials are known and are applied to plastics films, in particular for packaging applications, using methods of vacuum thin layer technology.

The deposition of superficial, defect-free coatings is not possible using the method of vacuum thin layer technology as the surfaces to be coated are not formed perfectly and cannot be produced totally dust-free. The defective points in the coating lead to an undesired residual permeability of the combination of barrier layer and plastics film.

To reduce the residual permeability of the system of plastics film/vacuum coating, it is known to paint over the barrier layer applied from the vacuum to the plastics film. This leads to covering or even blocking of the pores with the paint and hence to a reduced permeability of the pores. Paints which are known to this end are ormocers or for example the paint systems described in U.S. Pat. No. 5,645,923 which lead to an improvement of the barrier effect by up to a factor of 10. These paints, because of their organic components, cannot totally prevent the permeability through a pore but only reduce it, as they themselves are permeable to most gases, in particular water vapour.

Exclusively inorganically constructed lacquers such as sol/gel lacquers which are applied at temperatures suitable for normal plastics films and can be hardened, are not known.

Therefore, to reduce the residual permeability of the layer system further, for some years multilayer structures have been studied which are produced by alternating coating, by means of PVD or plasma CVD technology, with an inorganic barrier layer and a liquid paint layer to be hardened subsequently. The liquid paint layers have the task of covering the defects in the vacuum coating and providing again as perfect a surface as possible for the subsequent vacuum coating. Also, the paint layer should be able to be applied as thinly as possible and itself have as low a permeability as possible so that the sealing effect described above is achieved optimally by the paint layer.

The disadvantage with the prior art is that to achieve so-called flexible ultra-barrier structures with the required permeability for water vapour of <10⁴ g (m² 24 h), as required e.g. for flexible Oled displays or for organic photovoltaic structures, the required barriers are achieved only by very many (usually 5-10) layer pairs of paint layer and ceramic layer and the many coating processes lead to high costs and also high rejection rates in production.

To make progress in the field of ultra-barriers, in the vacuum coating also coating processes must be used which lead to very low defect rates. The sputter processes which are used are very slow coating processes and therefore very costly. Layers which are produced with vaporisation processes do not achieve the residual permeability per layer achieved with the sputter processes, so that for ultra-barrier applications even more layer pairs are required.

The invention is based on the object of providing a method of the type described initially with which, using ceramic barrier layers, the residual permeability for water vapour can be further reduced in comparison with the methods according to the prior art.

The object of the invention is achieved in that the ceramic barrier layers are coated with a solution of perhydropolysilazane (PHPS) and then hardened to form a silicon oxide layer.

PHPS can be applied to the barrier layers dissolved in an organic solvent. Suitable solvents are for example xylene or DBE (dibasic ester). DBE is a substance from a mixture of dimethylesters of glucaric, adipinic and succinic acids.

To apply PHPS to the ceramic layers, preferably a solution of max. 10 vol. %, preferably max 3 vol. % PHPS in organic solvent is used.

The coating which is applied to the ceramic layer can be hardened at a temperature suitable for normal plastics films of max. 100° C.

The coating applied to the ceramic layer can be hardened by irradiation with high-energy UV light.

With a carrier material with at least two barrier layers of ceramic material, on each barrier layer before deposition of the subsequent barrier layer, a PHPS solution is applied and hardened.

It has been shown that the liquid coating according to the invention with a PHPS solution gives an ideal “smooth coating” for the subsequent ceramic barrier layer.

In contrast to sol-gel lacquers which require relatively high temperatures of >250° C. to cross-link the inorganic Si—O—Si network, on use of perhydropolysilazane only moderate temperatures of <100° C. or UV hardening with high-energy UV light lead to a dense SiO₂ layer. To convert the PHPS to SiO₂, water is required in the form of moisture in the air, where then H₂ and NH₃ escape from the layer. The SiO₂ layer thicknesses are in the region of 500 nm.

Experiments have shown that above all a double PHPS coating of a ceramic layer reduces the permeability to water vapour, at a temperature of 38° C. and 90% relative humidity, from around 4 to 0.03 g/(m² 24 h), which corresponds to an improvement factor of around 100. On use of conventional lacquers such as sol-gel, epoxy-amine, acrylate paints, an improvement by a factor of only 10 is achieved. The oxygen barrier of a ceramic coating with two PHPS coatings is also clearly improved from around 2 cm³/(m² d bar) to <0.01 cm³/(m² d bar). Precise determination of the improvement factor is not possible due to the reaching of the unit measurement limit.

The flexible carrier material is for example a plastics foil present in the form of a strip, a plastics film or a laminate with a plastics film, on which the ceramic barrier layer is deposited.

The PHPS solution can for example be applied by means of smooth or grid rollers onto a plastics film present in strip form with ceramic barrier layer deposited thereon.

A suitable barrier layer of ceramic material is for example a ceramic layer of Al₂O₃ or SiOₓ produced in vacuum and from 10 nm to 200 nm thick. The preferred thickness of the ceramic layer of A1₂O₃ or SiOₓ is between around 40 and 150 nm.

In a first preferred variant, x in the ceramic layer of SiOₓ is a figure between 0.9 and 1.2, in a second preferred variant a figure between 1.3 and 2, in particular between 1.5 and 1.8.

1. A method for improving the permeability barrier effect for water vapor and gases in a flexible carrier material with at least one barrier layer of ceramic material, the at least one ceramic barrier layer is coated with a solution of perhydropolysilazane (PHPS) and then hardened to form a silicon oxide layer (SiOₓ).

2. The method according to claim 1, wherein PHPS is applied to the at least one ceramic layer dissolved in an organic solvent.

3. The method according to claim 2, wherein to apply PHPS to the at least one ceramic layer, a solution of max. of 10 vol. %.

4. The method according to claim 1, wherein the coating applied to the at least one ceramic layer is hardened at a temperature of max. 100° C.

5. The method according to claim 1, wherein the coating applied to the at least one ceramic layer is hardened by irradiation with high-energy UV light.

6. The method according to claim 1, wherein the PHPS solution is applied to the at least one ceramic layer by means of smooth or grid rollers.

7. The method according to claim 1, wherein for a carrier material with at least two barrier layers of ceramic material, a PHPS solution is applied onto each barrier layer and hardened before formation of the subsequent ceramic barrier layer.

8. The method according to claim 2, wherein the coating applied to the at least one ceramic layer is hardened at a temperature of max. 100° C.

9. The method according to claim 3, wherein the coating applied to the at least one ceramic layer is hardened at a temperature of max. 100° C.

10. The method according to claim 2, wherein the coating applied to the at least one ceramic layer is hardened by irradiation with high-energy UV light.

11. The method according to claim 3, wherein the coating applied to the at least one ceramic layer is hardened by irradiation with high-energy UV light.

12. The method according to claim 2, wherein the PHPS solution is applied to the at least one ceramic layer by means of smooth or grid rollers.

13. The method according to claim 3, wherein the PHPS solution is applied to the at least one ceramic layer by means of smooth or grid rollers.

14. The method according to claim 4, wherein the PHPS solution is applied to the at least one ceramic layer by means of smooth or grid rollers.

15. The method according to claim 8, wherein the PHPS solution is applied to the at least one ceramic layer by means of smooth or grid rollers.

16. The method according to claim 9, wherein the PHPS solution is applied to the at least one ceramic layer by means of smooth or grid rollers.

17. The method according to claim 5, wherein the PHPS solution is applied to the at least one ceramic layer by means of smooth or grid rollers.

18. The method according to claim 10, wherein the PHPS solution is applied to the at least one ceramic layer by means of smooth or grid rollers.

19. The method according to claim 11, wherein the PHPS solution is applied to the at least one ceramic layer by means of smooth or grid rollers.

20. The method according to claim 2, wherein for a carrier material with at least two barrier layers of ceramic material, a PHPS solution is applied onto each barrier layer and hardened before formation of the subsequent ceramic barrier layer.

21. The method according to claim 3, wherein for a carrier material with at least two barrier layers of ceramic material, a PHPS solution is applied onto each barrier layer and hardened before formation of the subsequent ceramic barrier layer.

22. The method according to claim 4, wherein for a carrier material with at least two barrier layers of ceramic material, a PHPS solution is applied onto each barrier layer and hardened before formation of the subsequent ceramic barrier layer.

23. The method according to claim 5, wherein for a carrier material with at least two barrier layers of ceramic material, a PHPS solution is applied onto each barrier layer and hardened before formation of the subsequent ceramic barrier layer.

24. The method according to claim 15, wherein for a carrier material with at least two barrier layers of ceramic material, a PHPS solution is applied onto each barrier layer and hardened before formation of the subsequent ceramic barrier layer.

25. The method according to claim 16, wherein for a carrier material with at least two barrier layers of ceramic material, a PHPS solution is applied onto each barrier layer and hardened before formation of the subsequent ceramic barrier layer.

26. The method according to claim 18, wherein for a carrier material with at least two barrier layers of ceramic material, a PHPS solution is applied onto each barrier layer and hardened before formation of the subsequent ceramic barrier layer.

27. The method according to claim 19, wherein for a carrier material with at least two barrier layers of ceramic material, a PHPS solution is applied onto each barrier layer and hardened before formation of the subsequent ceramic barrier layer.

28. The method according to claim 1, wherein PHPS is applied to the at least one ceramic layer dissolved in xylene or DBE (dibasic ester).

29. The method according to claim 2, wherein to apply PHPS to the at least one ceramic layer, a solution of max. of 3 vol. % PHPS in organic solvent is used.
